(19) United States
(12) Patent Application Publication
(10) Pub. No.: US 2007/0258143 A1
(43) Pub. Date: Nov. 8, 2007

(54) Aspheric multifocal diffractive ophthalmic lens

(76) Inventor: Valdemar Portney, Tustin, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 11/496,894

(22) Filed: Jul. 31, 2006

Related U.S. Application Data
(60) Provisional application No. 60/798,518, filed on May 8, 2006.

(51) Int. Cl. G02B 27/44

(52) U.S. Cl. 359/565; 351/168

(57) ABSTRACT

A multifocal ophthalmic lens includes a lens element having an anterior surface and a posterior surface, a refractive zone, or base surface having aspherically produced multifocal powers disposed on one of the anterior and posterior surfaces; and a near focus diffractive multifocal zone disposed on one of the anterior and posterior surfaces.

The present application claims priority from U.S. Provisional Application Ser. No. 60/798,518 filed May 8, 2006, this referenced application being incorporated herein in it's entirety by this specific reference thereto.

### FIELD OF THE INVENTION

The present invention relates generally to multifocal ophthalmic lenses, and more particularly to multifocal lenses which provide diffractive powers with improved intermediate vision associated with the enhanced depth of focus at distant vision.

### BACKGROUND OF THE INVENTION

Ophthalmic lens is defined as a lens suitable for carrying on the eye or inside the eye. Also included are less common vision correction lenses such as artificial corneas and lamellar corneas implants. There is a significant effort to develop a lens for presbyopia correction in a form of refractive or diffractive type lenses.

A fixed single power lens provides good quality of vision but only within a small range of viewing object distances that is usually significantly narrower than the range required for near to distant vision. An improved type of the implant provides a number of powers, so called bifocal or multifocal lens. Reference to bifocal or multifocal terminology is used herein interchangeably. The multifocal ophthalmic lens can provide refractive powers, diffractive powers or a combination of both for required range of vision.

Although refractive lenses were first to be developed they may be interpreted as a specific state of diffractive optics and it may be more appropriate to address a diffractive optic definition in order to describe refractive and diffractive surface types. A diffractive lens generally consists of a number of annular surface zones of equal area, so called Fresnel type zones or grooves. The optical steps are provided between the adjacent zones that follow the specific rule hereinbelow described. If step sizes are zero or are randomly sized or groove areas are also randomly sized, the lens becomes a refractive type, i.e. the corresponding image locations are defined by Snell's law.

A diffraction lens can be considered as a combination of refractive lens formed by zero step size so called base curve and phase grating, see FIG. 1. A phase grating can be formed by different types of zone or groove shapes where the blaze shape shown on the FIG. 1 is the most common one. Thus, a blaze shape is cut into a base refractive surface to introduce a phase grating, i.e. a periodic array of optical scattering regions.

Scattering light in all directions by the periodic structure creates constructive and destructive interference of light at different but specific angles depending on wavelength of light which are called diffraction orders. The corresponding wavelength of light used to design the phase grating is called design wavelength.

The directions of the orders and corresponding image locations are defined by the Grating formula, not Snell's law. Zero-order diffractive power coincides with the power of the refractive surface formed by the base curvature and, therefore, loosely called refractive power of the diffractive lens. The key point for the grating to perform, i.e. to form distinct diffraction orders, is to have equal areas of Fresnel zones (grooves) and equal Optical Path Differences between adjacent zones at their borders (OPD_{b}) in the direction of each diffraction order.

According to the wave nature of light, constructive interference of light from different grating regions occurs if light is in phase at the corresponding image plane. The constructive interference would maintain if the light from one of the regions is shifted by the full phase equaled to integer number of the design wavelength. For instance, zero order corresponds to the original direction of the light produced by the refractive base curve, i.e. zero phase shift between light coming from each adjacent blaze zone, 1^{st} order is produced by the phase of one wavelength shift between each adjacent blaze, 2^{nd} order is produced by the phase of two wavelengths shift between each adjacent blaze and so on. Grating period or blaze zone spacing determines an angle of the given diffractive order, i.e. the corresponding focal length or diffractive power of the given diffraction order.

By the definition of the diffraction order, light can only be channeled along the diffraction orders of the diffractive lens, i.e. discrete channels, but the percent of totally available light that is actually channeled for a given diffraction order depends upon the light phase shift introduced by each blaze zone, i.e. blaze material thickness (h), see FIG. 1. The percent of total light at a given order is called diffraction efficiency of this order. In general terms one can call it a light transmittance for the given order.

According to the “geometrical model” of the grating 100% efficiency (light transmittance) in m-order can be achieved if the direction of the blaze ray defined by the refraction at the blaze coincides with the direction of m-order diffraction, (Carmiña Londoño and Peter P. Clack, Modeling diffraction efficiency effects when designing hybrid diffractive lens systems, Appl. Opt. 31, 2248-2252 (1992)). It simply means that blaze material thickness is selected to direct the blaze ray along the m-order diffraction produced by the blaze zone spacing for the design wavelength of light.

The “geometrical model” provides a simple explanation of the diffractive lens structure which is important in a description of the present invention instead of relying on the mathematics of phase function, transmission function and its Fourier series to calculate diffraction efficiencies and solving the diffraction integral for intensity distribution.

For instance, if the blaze ray is refracted along the middle direction between zero-and (−1)-order, then the diffraction efficiency is equally split between zero- and-1^{st}-orders and the resulted blaze height is half of the one required for 100% efficiency at (−1)-order. Still one has to go through the formal process of calculation to determine that the efficiency of (−1)- and zero-order each equals to 40.5% for the design wavelength for the corresponding diffractive lens structure and the rest of light directed along higher orders of diffraction. In terms of the terminology, one can state that light transmittance to zero and (−1) diffraction order each equals 40.5%.

Choosing the appropriate blaze spacing (rⱼ) and blaze material thickness (hₘ) as set forth hereinbelow, one can produce diffractive lens of the appropriate focal length (fₘ) required by the ophthalmic lens application.

In a simple paraxial form the circular grating zones, also called echelettes or surface-relieve profile or grooves, can be expressed by the formula r²ⱼ=jmλf, i.e. the focal length of m-order diffraction (m=0, ±1, ±2, etc) for the design wavelength (λ) can be closely approximated by the following formula:

$${f}_{m} = \frac{{r}_{j}^{2}}{jm λ} \qquad ( 1 )$$

In the paraxial approximation the blaze material thickness to produce 100% efficiency at m-order is

$${h}_{m} = \frac{m λ}{( n - {n}^{′} )} \qquad ( 2 )$$

where n=refractive index of the lens material and n′=refractive index of the surrounding medium.

A diffractive surface may be formed by different shapes of the periodic diffractive structure and not only by specific blaze shape and for the generality of this invention the term “groove” is used as the description of the variety of shapes of the diffractive structure.

U.S. Pat. No. 5,096,285 by Silberman describes diffraction surface with 100% efficiency to provide single diffraction power and the invention does not utilize the main advantage of the diffractive optic to use several diffraction orders (zero and −1, or +1 and −1, etc.) to reduce pupil dependency of the bifocal ophthalmic lens performance.

U.S. Appl. No. 20050057720 by Morris describes also diffractive 100% efficiency surface with the utilization of multiorder diffractive surface (MOD), i.e. the zones having boundary condition of phase shift by the multiple wavelength to provide similar diffraction efficiency for the range of wavelengths instead of only for the design wavelength.

Cohen and Freeman are the principal inventors of ophthalmic multifocal diffractive optic that utilizes several diffractive orders to form image from the objects at different distances. The Cohen patents: U.S. Pat. Nos. 4,210,391; 4,338,005; 4,340,283; 4,881,805; 4,995,714; 4,995,715; 5,054,905; 5,056,908; 5,117,306; 5,120,120; 5,121,979; 5,121,980 and 5,144,483. The Freeman patents: U.S. Pat. Nos. 4,637,697; 4,641,934; 4,642,112; 4,655,565, 5,296,881 and 5,748,28 where the U.S. Pat. No. 4,637,697 references to the blaze as well as step-shapes (binary) diffractive surface.

Other patents on diffractive lenses have been granted to Futhey: U.S. Pat. Nos. 4,830,481, 4,936,666, 5,129,718 and 5,229,797; Taboury: U.S. Pat. No. 5,104,212; Isaacson: U.S. Pat. No. 5,152,788; Simpson: U.S. Pat. Nos. 5,076,684 and 5,116,111 and Fiola: U.S. Pat. Nos. 6,120,148 and 6,536,899.

Swanson in U.S. Pat. No. 5,344,447 describes tri-focal lens using binary type diffractive surface profile. Kosoburd in U.S. Pat. No. 5,760,871 also describes tri-focal lens with blaze and binary profiles.

Several patents describe the variable step size between the adjacent zones of the diffractive structure to control light transmittance at different diffraction orders with pupil size: U.S. Pat. Nos. 4,881,805 and 5,054,905 by Cohen describe so called progressive intensity bifocal lens where the step size at the adjacent zones reduced towards periphery to shift larger portion of light towards zero-order (far focus) diffraction image, i.e. to control light transmittance to the given order with pupil diameter. Baude et al in U.S. Pat. No. 5,114,220 discloses an ophthalmic lens which characteristically comprises at least two concentric regions having diffractive components with different phase profiles in order to use different orders of diffraction. Lee et al in U.S. Pat. No. 5,699,142 incorporates a similar concept into so called apodized lens by recommending the specific reduction in echelettes heights, so called apodization the diffractive surface echelettes heights, to split light initially equally between Far and Near foci (40.5% efficiency for each) and them the heights reduce towards lens periphery to shift larger portion of light towards far focus with larger pupil size, i.e. to control light transmittance with pupil diameter. Freeman in U.S. Pat No. 5,748,282 also refers to the variable step size to control light intensity between different orders with pupil size variation.

U.S. Pat. No. 5,056,908 discloses an ophthalmic contact lens with a phase plate and a pure refractive portion within its optic zone that is placed at the periphery of phase zone area. U.S. Pat No. 5,089,023 by Swanson also describes the lens with a combination of single focus refractive and diffractive segments that can be of bifocal design. In both inventions the refractive portion coincides with one of the diffractive order either for distant or near vision.

Thus, the diffractive optic offers the advantage to perform independently to pupil diameter. Common to all designs of the quoted patents is the fact that a bifocal diffractive lens is lacking intermediate vision. It has been shown that bifocal diffractive lens demonstrates two distinct intensities at two foci for distant and near vision (Golub M A, et al, Computer generated diffractive multi-focal lens. J. Modem Opt., 39, 1245-1251 (1992), Simpson M J. Diffractive multifocal intraocular lens image quality. Appl. Optics, 31, 3621-3626 (1992) and Fiala W and Pingitzer J. Analytical approach to diffractive multifocal lenses. Eur. Phys. J. AP 9, 227-234 (2000)). A presence of some intermediate vision reported clinically can be attributed to the aberrations of the ocular system of a given subject and not to the lens design itself.

U.S. Pat. Nos. 5,864,374; 6,024,447 and 6,126,286 by Portney discloses refractive monofocal ophthalmic lens with an enhanced depth of focus as a combination of different corrective powers. U.S. Pat. No. 6,923,539 by Simpson also discloses monofocal refractive ophthalmic lenses that exhibit extended depth of field. The patent provides an example of surface profile.

Tecnis multifocal diffractive lens by Advanced Medical Optics is of the design with aspheric surface of a distant focus placed on the front surface of the lens and multifocal diffractive structure to form distant and near foci is placed on the back surface of the lens. The objective of Tecnis multifocal design is to improve image contract of distant vision at large pupils above 4 mm diameter by reducing optical aberration of the Eye implanted with Tecnis multifocal diffractive lens. U.S. Pat. Appl. No 2006/0116764 by Simpson describes an aspheric multifocal diffractive lens with an aspheric surface serving as base surface of the multifocal diffractive surface. Optically it does not matter which surface is asphrized, refractive one or diffractive base surface for distant vision because a diffractive multifocal structure interacts with a wavefront resulted by a combination of both surfaces and it doesn't matter which one is aspherized for aberration reduction. Therefore, the outcome of the design is similar to one of the Tecnis multifocal to correct for eye aberrations and, as a result, to improve image contrast of distant vision at large pupil. U.S. Pat. Appl. No 2006/0116764 by Simpson also included apodized diffractive multifocal design as an additional feature to control light distribution between distant and near foci.

Neither Tecnis no Simpson's design describes aspheric multifocal surface in combination with multifocal diffractive design to extend Depth of Focus at distant vision or provide intermediate foci in addition to distant and near foci. Therefore, the corresponding lenses are lacking important attributes of the multifocal ophthalmic optic:

(a) intermediate focus (viewing of a computer screen, for instance) and

(b) low sensitivity to a refractive error as the lens performance should not drop significantly with small lens misalignment or power miscalculation. Both Tecnis and Simpson's design have high sensitivity to a refractive error due to narrow Depth of Focus for distant focus associated with the reduction of the eye aberration. A reduction in aberrations improves the vision quality (image contrast) at the image focus but a small deviation from this ideal focus position rapidly reduces image quality. Such a performance might be suitable for near vision where a subject may control the distance to viewing object o adjust for best focus position but is detrimental for distant vision because small refractive errors are commonly occurred and where correction would require spectacles or contact lenses.

In U.S. Pat. No. 7,073,906 to Portney multifocality of an aspheric diffractive lens is placed at a refractive zone internally to a diffractive zone. “Multifocality” is defined as a presence of intermediate focus in addition to distant focus or having a range of foci that includes distant focus to expand Depth of Focus (DOF) around distant focus. The present invention provides for multifocality up to a periphery of the diffractive multifocal zone.

In other words, the multifocality is extended from being inside of a diffractive annular zone to a diffractive zone peripheral edge. Accordingly, a method in accordance with the present invention includes calculation of surface diffractive structure in order to produce (−1) order diffraction for near focus which is distinct from definitions used by the prior art.

The objective of the present invention is to provide a multifocal diffractive lens with the ability to offer a vision covering far, intermediate and near foci. The foci may provide continuous vision covering far, intermediate and near. The later case provides a naturally occurred vision similar to one through a pin-hole where a person can observe objects continually from far to near distances but without necessity to have small pupil (pin-hole) and, as a result, a very limited amount of light reaching the retina. The expectation of the lens performance according to the present invention is that the characteristic of the images of the objects at all distances from far to near are naturally occurred (pin-hole, for instance) and would inhibit a minimum of ghosting and halos commonly observed with present types of diffractive and refractive multifocal ophthalmic lenses.

The related objective of this invention is to provide multifocal diffractive lens with extended depth of focus (DOF) at far image in order to increase tolerance of distant vision to small refractive errors. This relates to the introduction of an intermediate foci in addition to near and distant foci far commonly utilized in prior art diffractive multifocal optic designs.

### SUMMARY OF THE INVENTION

A lens in accordance with this invention consists of front and back surfaces. The lens includes multifocal diffractive zone (diffractive structure) to create a multifocal optic for near and distant foci and multifocal surface on the other surface of the lens, so called “opposite surface” that includes intermediate foci in addition to distant foci or range of foci including distant focus. Another embodiment of this invention includes multifocal diffractive zone that produces near focus with multifocal base surface of the diffractive structure that produces intermediate foci in addition to distant focus or range of foci including distant focus. This, this multifocal opposite surface or multifocal base surface includes a range of foci that includes distant focus to increase depth of focus at distant vision or intermediate and distant foci in order to provide a range of powers or several discrete refractive powers. The form of the multifocal opposite surface or multifocal base surface can be aspheric or discrete spherical that enhances depth of focus (DOF) around distant vision or introduce intermediate focus in addition to distant focus.

The opposite surface or base surface may cover a zone of refractive surface, i.e. the definition of “opposite surface” or “base surface” includes all lens surface up to the diameter equal to the diameter of the peripheral edge of the diffractive zone. For instance, a refractive zone may occupy a central portion of the lens and diffractive zone is an annulus around it. The “opposite surface” means the surface on the opposite lens surface from the surface with the diffractive zone with the diameter equal to the peripheral diameter of the diffractive zone, i.e. the light passing through the opposite surface passes also central refractive zone and diffractive annulus. The “base surface” means the total surface of the central refractive zone and surface associated with the base curve of the diffractive zone, i.e. the light passing the base surface passes through the central refractive zone and diffractive annulus. In optical terminology the result is a multifocal zero-order diffraction.

The aspheric surface in accordance with the present invention increases aberrations vs. a corresponding spherical lens by including several powers of vision (intermediate power in addition to distant power) or the foci spread around the best image position in order to increase the depth of focus around this best image position. The present invention adds to this aspheric surface a diffractive structure to produce a near focus in addition to the aspheric multifocal powers.

The described above two embodiments are structurally different but they may actually provide the same optical outcome for distant vision because their multifocal effect may be the same either the multifocal structure is placed on base surface of the diffractive lens or the surface that is opposite to the diffractive one. Optically, the diffractive structure interfaces with a wavefront created by both surfaces (opposite and base surfaces) to create multiple orders. Thus, optically one may refer to the opposite surface and base surface interchangeably because both of them together produce a multifocal wavefront that is responsible for multifocal zero-order diffraction and which interacts with the diffractive structure to produce non-zero order diffraction (usually −1-order) for near focus, i.e. one can use either one or combination of both to produce intermediate focus in addition to distant focus or enhance depth-of-focus around distant focus. Note, both surfaces, opposite and base surfaces may by structurally made multifocal surfaces but this would increase a cost of making the lens.

As a matter of terminology we can call the resulted lens as aspheric diffractive lens regardless if a multifocal structure is placed at the base surface or opposite surface or both.

The appropriately designed diffractive structure is to create a near focus as non-zero diffraction order (usually −1-order) in addition to the distribution of foci created by either opposite to the diffractive zone surface or the base surface of the diffractive surface serving as zero-order diffraction. Due to grating nature of the diffractive structure to channel light only along the channel of non-zero order, the resulted near focus can optically be only as a single focus for each diffraction order, i.e. the diffractive structure may produce a wavefront for near vision of a complex form (aspheric or multifocal) but only the light that is focused very close to the near focus forms the near image and the rest of the light just spread out within other orders thus reducing the efficiency of near image. It means that appropriately designed diffractive structure should produce a spherical wavefront with the center at the near focus where all light is focused to this near focus to maximize the near focus efficiency. The unexpected outcome of the inventions is the method of calculating the appropriate diffractive structure to a maximum efficiency for near vision.

The multifocal diffractive zone can be a central zone or annulus preferably within the range of pupil diameters of 3 to 6 mm.

Thus, the resulted aspheric multifocal diffractive zone is characterized by a diffractive structure over the aspheric multifocal base surface or by the diffractive structure over the spherical base surface with the aspheric multifocal opposite surface or a combination of both. It would be less expensive in general to have multifocal base surface and a spherical opposite surface because only one surface of the lens becomes an unconventional special surface and another is maintained as a conventional surface for easier fabrication instead of having both unconventional surfaces of the lens.

An aspheric multifocal base surface will be discussed below though an aspheric multifocal diffractive lens can be created either by the multifocal opposite surface or multifocal base surface or a combination of both. A corresponding refractive lens constructed with the surface identical to the multifocal base surface of the diffractive surface includes intermediate and distant foci of a range of foci around distant focus that produces enhanced depth of focus around distant focus. The diffractive structure over the multifocal base surface is such that the resulted non-zero order diffraction produces the wavefront that is compliment to the sag of the multifocal base surface of zero-order to channel light along the corresponding non-zero order diffraction corresponding to near focus. In the preferable embodiment, the non-zero-order diffraction is (−1)-order.

The multifocal base surface may be such that the curvature increases to some intermediate power level and then reduces to distant power level or even beyond the distant focus. The changes between intermediate and far power levels may repeat several times continuously or in discrete steps to minimize an impact of pupil diameter change. As a result, the zero-order image is spread over intermediate and distant foci. The diffractive structure over the multifocal base surface channels light to near focus, i.e. a combination of multifocal base surface and diffractive structure produces a near spherical wavefront with the center at the near focus.

A similar multifocal surface that introduces intermediate focus in addition to distant focus or enhances depth of focus of distant vision can also be placed on the surface opposite to the base surface with light passing though both surfaces in sequence, i.e. first through the multifocal diffractive surface and than opposite surface or opposite surface and than multifocal diffractive surface. Calculation of the diffractive structure in this is more complicated as one has to take into account of the wavefront transfer between the surfaces.

It is important to comment that near focus spherical wavefront must be a final wavefront created by the whole eye optical system, i.e. the appropriate diffractive structure places on any of the surfaces of the system must take into account all system surfaces to create the final near focus spherical wavefront at the exit of the eye optical system. Few examples: (a) the diffractive structure is placed at the posterior of the aphakic IOL that replaces natural crystalline lens, i.e. it is the last surface of the eye optical system; (b) the diffractive structure may be placed at the posterior of the phakic lens positioned at the front of the natural crystalline lens, i.e. it is interim surface but its design should include an optical contribution of the crystalline lens to result in a near spherical wavefront for near focus; (c) the diffractive structure may be at the posterior surface of the contact lens with the cornea and natural crystalline lens following it and their optical contribution should be taken into account in designing the appropriate diffractive structure to create final near spherical wavefront for near focus.

Either multifocal surface with intermediate and far foci or range of foci that enhances depth of focus at distant vision is at the opposite surface of base surface the resulted multifocal wavefront becomes so called base wavefront that interferes with the diffractive structure to create near focus on the top of the multifocal zero-order diffraction.

The phase change along the surface may be quite rapid due to multifocality of zero-order diffraction and, as a result, the diffractive structure in terms of the groove width, for instance, becomes very narrow. The lens may be a combination of zones with alternating diffractive structures on it. For instance, a refractive zone may be internal or peripheral to the diffractive structure. If the refractive zone is of aspheric construction with intermediate and far foci or depth of focus enhancing design, than the diffractive zone may have base surface that is spherical or aspheric design to correct for aberrations. Together the zones produce the lens with multifocal zero-order diffraction and near focus (−1)-order diffraction to cover intermediate, distant and near foci of the lens with enhanced depth of focus performance at distant vision vs. prior art diffractive multifocal lens with only distant and near foci and narrow depth of focus at distant image.

A method of producing diffractive multifocal surface in accordance with the present invention includes:

a) selecting the location (central or annular) and surface placement (opposite or base surface) for the multifocal surface;

b) selecting a multifocal form that enhances DOF around far (distant) focus or surface variation at intermediate and far foci;

c) selecting a location (central or annular) and surface placement (front or back) for the diffractive multifocal structure.

d) calculating diffractive structure phase coefficients that produce near spherical wavefront for near focus for a selected add power to serve as non-zero order diffraction for the aspheric diffractive lens with multifocal zero-order diffraction. Usually (−1)-order diffraction is allocated to near focus.

$${Φ}_{- 1} ( r ) = \frac{2 π}{λ} [ {a}_{1} r + {a}_{2} {r}^{2} + … + {a}_{n} {r}^{n} ] \qquad ( 3 )$$

Formula 1 is (−1)-order (near focus) phase function with phase coefficients αᵢ calculated over the contribution of the eye optical system that includes the multifocal opposite or base surface in a form of their sags contribution. The resulted wavefront should be close to spherical wavefront to maximize the efficiency for near image. The corresponding optimization for the phase coefficients αᵢ can be performed by conventional optical design software, Zemax, for instance;

e) numerically calculating the first groove shape that produces the defined above phase coefficients that directs 100% of light to the diffractive near focus . The groove width is defined by the phase function modulo 2π, i.e. phase function cycles by 2π period where the groove height drops to zero for each consecutive groove, formula 4.

$$h ( {r}_{i} ) = \{ {[ {Φ}_{- 1} ( {r}_{i} ) ]}_{2 π} \} \frac{λ}{2 π ( n - {n}^{′} )} , \qquad ( 4 )$$

where rᵢ=radial numerical sampling with small enough step, for instance, 5 microns step

The maximum groove height is defined by formula 2, i.e.

$$\frac{λ}{( n - {n}^{′} )} for ( - 1 ) - order diffraction$$

Phase function could be of modulo 2πp where p=2, 3, etc. for multi-order diffraction design The groove's width is not defined now by a simple formula 1 where the base wavefront is close to spherical shape to produce single focus zero-order diffraction for distant focus. The width becomes derivative of the complex wavefront shape produced by the eye optical system including the multifocal opposite or base surface;

f) selecting the step height for the first groove of the diffractive zone to create a required balance of light between multifocal zero-order diffraction and (−1)-order diffraction for near focus. Different methods of groove height calculation can be used. This invention describes the method that is based on the “geometrical model”, i.e. defined by the direction of the blaze ray and the corresponding diffraction efficiencies defined by the rigorous diffraction theory: (1) equal diffraction efficiencies of 40.5% for zero-order and (−1)-order diffractions if the blaze ray direction is exactly in the middle between the directions of these orders; (2) diffraction efficiency for distant or near is 100% if the blaze ray direction coincides with a direction of either zero-order or (−1)-order diffraction. FIG. 2 below provides a graphical explanation of the geometrical model. In accordance with this model a relative direction of the blaze ray can be translated to a groove shape by the formula 5:

$${h}^{′} ( {r}_{i} ) = \frac{S - [ {T}_{0} ( {r}_{i} ) - {T}_{- 1} ( {r}_{i} ) ]}{2 S} \cdot h ( {r}_{i} ) = K ( {r}_{i} ) \cdot h ( {r}_{i} ) \qquad ( 5 )$$

where h(rᵢ) is calculated in accordance to formula 4;
T₀(rᵢ)=transmittance to or diffraction efficiency of 0-order diffraction;
T₋₁(rᵢ)=transmittance to or diffraction efficiency of near focus, i.e. (−1)-order diffraction;
T₀(r)+T₋₁(r)=S, where S is within 0.81 to 1.0.

Coefficient K(rᵢ) acts as the normalization coefficient for transmittance to otherwise the diffractive structure with 100% transmittance to (−1)-order for near focus.

S is 0.81 if the blaze ray direction is exactly in the middle between the directions to near and distant foci and, as a result, equal efficiencies for near and distant foci of 40.5%. It is 1.0 if blaze ray direction coincides either with zero-order diffraction or (−1)-order diffraction and, as a result, the corresponding diffraction efficiency for distant or near is 100%. One can take S as a constant between 0.81 and 1.0, say 0.9 if the blaze ray angle varies between directions to near and distant foci. More sophisticated option is to vary S within 0.81 and 1.0 depending upon the actual direction of the blaze ray for a given groove's location rᵢ in reference to the direction to distant and near foci:

$$S = 0.19 \cdot X + 0.81 , where X = {[ \frac{{T}_{0} ( {r}_{i} ) - {T}_{- 1} ( {r}_{i} )}{{T}_{0} ( {R}_{i} ) + {T}_{- 1} ( {r}_{i} )} ]}^{2} .$$

g) the process of (e) and (f) calculations is repeated for the consecutive grooves until reaching the peripheral edge of the multifocal diffractive zone.

### BRIEF DESCRITION OF THE FIGURES

FIG. 1 illustrates a prior art diffractive lens with blazed periodic structure forming different diffraction orders along which the light can only be channeled. The figure also include a description of a “geometrical model” of the diffractive lens through the relationship between the blaze ray defined by the refraction at the blaze and directions of the diffraction orders;

FIG. 2 illustrates a portion of aspheric multifocal diffractive lens of this invention with blazed periodic structure forming multifocal base surface for zero-order and (−1)-order diffraction for near focus along which the light is channeled. The diffractive structure is placed on the posterior surface of the lens but it can be placed on the anterior surface as a different embodiment. A multifocal asphere can be placed at the base surface as a different embodiment. The FIG. 2 incorporates also a description of a “geometrical model” of the diffractive lens through the relationship between the blaze ray defined by the refraction at the blaze and directions of the diffraction orders;

FIG. 3 is a plan view of a preferred embodiment of a lens made in accordance with the present invention, which has aspheric multifocal diffractive central zone;

FIG. 4 is a plan view of a preferred embodiment of a lens made in accordance with the present invention, which has aspheric multifocal diffractive zone as annulus;

FIG. 5 is a Power Profile of the lens described in the FIG. 3.

FIG. 6 is a Power Profiles of the lens described in the FIG. 4.

FIG. 7 shows Power Profiles of the lens described also on FIG. 4 but with different central zones.

FIG. 8A and 8B are profile views of aspheric multifocal diffractive zone.

FIG. 9 is a plan view of a preferred embodiment of a lens made in accordance with the present invention, which has multifocal diffractive central zone and aspheric refractive zone outside it that includes intermediate and far foci. The aspheric refractive zone may incorporate an enhancing DOF form. The aspheric multifocal refractive zone and diffractive zone may be on the same or opposite lens surfaces;

FIG. 10 is a plan view of a preferred embodiment of a lens made in accordance with the present invention, which has multifocal diffractive zone as annulus and aspheric multifocal refractive zone outside it with intermediate and far foci. The aspheric refractive zone may incorporate the enhancing DOF form. The aspheric refractive zone and diffractive zone may be on the same or opposite lens surfaces;

FIG. 11 is the example of an IOL Power Profile where the IOL is taken by itself The Power Profile includes the near power distribution and Base (Far) power distribution. The base surface manifests a multifocal surface covering intermediate and far powers as well as being aspherized.

FIG. 12 is the example of an Eye Power Profile where the IOL is part of the Eye optical system. The Power Profile includes the near power distribution of a single power and Base (Far) power distribution. The base surface manifests a multifocal surface covering intermediate and far powers as well as being aspherized.

FIG. 13 demonstrates a Modulus of the Optical Transfer Function for different focus positions, so called Through Focus Response (TFR). The TFR graph represents image quality of the eye with preferred embodiment of the aspherical diffractive multifocal lens.

### DETAILED DESCRITION

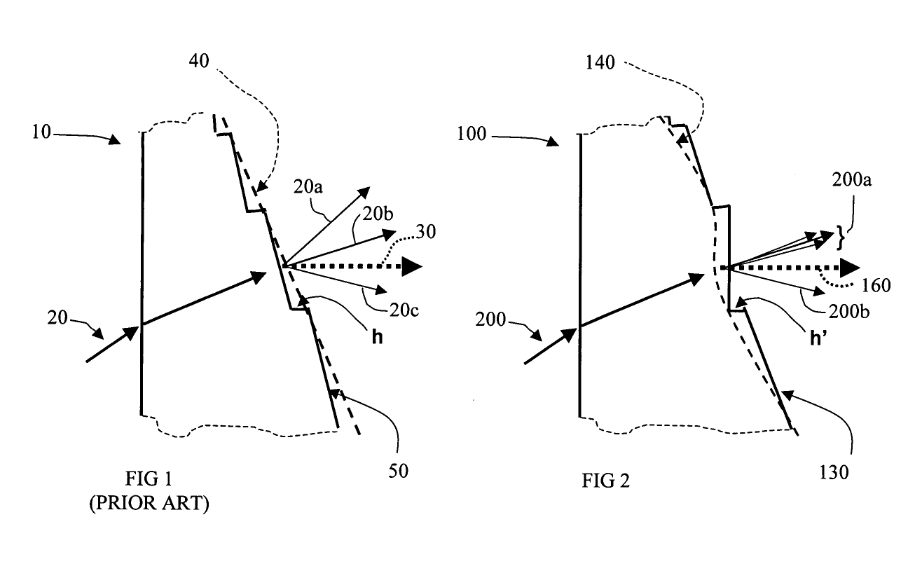

FIG. 1 describes a portion of a prior art diffractive lens 10 with blazed periodic structure 50 creating different diffraction orders indicating by the directions 20a, 20b, 20c, etc. along which the light can only be channeled. The figure includes input light ray 20 refracted by the lens 10. It also shows the refractive base curve 40 that would refract the exiting ray corresponding to the input ray 20 along the direction of zero-order diffraction 20b. Direction of (+1)-order diffraction is shown by 20a and (−1)-order diffraction by 20c. Theoretically, there are infinite orders of diffraction.

The FIG. 1 incorporates a reference to the “geometrical model” of diffractive lens by including blaze ray 30 as the ray corresponding to the input ray 20 and refracted by the blaze. The direction of the blaze ray 30 differs from the direction of 0-order diffraction 20b due to the different refraction angles of the rays at the base curve 40 and blaze structure 50. The angle difference is created by the blaze material thickness (h).

If the blaze material thickness h is zero than the blaze structure 50 coincides with the base curve 40 and the lens becomes pure refractive type. If the blaze material thickness (h) increases to refract the blaze ray 30 along (−1)-order of diffraction 20b the lens becomes a Kinoform with 100% efficiency at (−1)-order diffraction. The blaze ray 30 at the FIG. 1 is placed in the middle between 0-order and (−1)-order diffraction to equally channel the light between these two orders. The rigorous diffraction theory demonstrates that maximum 40.5% of light can be channeled along each of these orders for the given design wavelength with the rest of the light is spread out between the higher orders of diffraction. In the present multifocal diffractive designs 0-order diffraction is selected to coincide with the power for Far vision (Far power) and (−1)-order coincides with the power required for Near vision (Near power).

FIG. 2 describes a portion of diffractive lens 100 according to the present invention with blazed periodic structure 130 creating different diffraction orders indicating by the directions 200a (zero-order) and 200b (higher order), etc. along which the light can only be channeled. The figure includes input light ray 200 refracted by the lens 100. It also shows the aspheric refractive base curve 140 that would refract the exiting ray corresponding to the input ray 200 along the directions of zero-order diffraction 200a for the given lens segment. There is a range of directions due to underlying asphericity of the base curve. The shape of the base curve is such that the corresponding refractive lens enhances the depth of focus around far focus. Direction of (−1)-order diffraction is shown by 200b.

The corresponding aspheric shape may be applied to the other surface and the base curve of the multifocal diffractive zone may be conventional spherical shape. In either case if the enhancing DOF aspheric zone placed on the other surface or serves as the base curve of the diffraction zone, the lens zero-order diffraction forms a wavefront that enhances DOF around distant vision or have a combination of intermediate and far foci. There is a range of directions of zero-order diffraction 200a due to underlying asphericity of the enhancing DOF aspheric zone.

The FIG. 2 incorporates a reference to the “geometrical model” of diffractive lens by including blaze ray 160 as the ray corresponding to the input ray 200 and refracted by the blaze. The direction of the blaze ray 160 differs from the directions of 0-order diffraction 200a due to the different refraction angles of the rays at the base curve 140 and blaze structure 130. The angle difference is created by the blaze material thickness (h′).

If the blaze material thickness h′ is zero than the blaze structure 130 coincides with the base curve 140 and the lens becomes pure aspheric refractive type. If the blaze material thickness (h′) increases to refract the blaze ray 160 the light is split between 0-order and (−1)-order diffraction to channel the light between these two orders.

The blaze width and height does not follow now simple equations (1) and (2) but are such to compliment the sag variation of the aspheric base curve in order to result in the constructive interference at near focus by non-zero diffractive order.

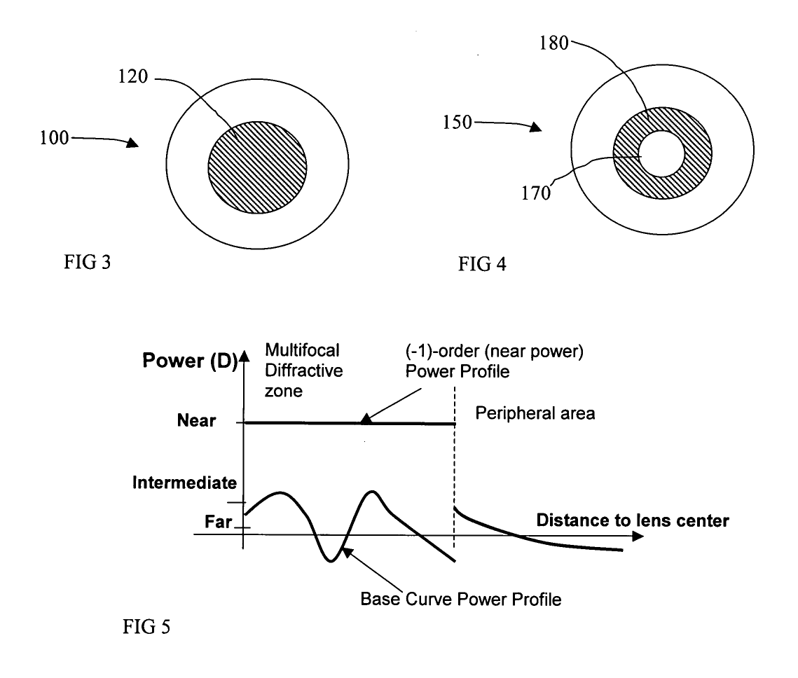

FIG. 3 is a plan view of a preferred embodiment of the ophthalmic lens 100 made in accordance with the present invention which has multifocal diffractive central zone 120 FIG. 3 demonstrates the central zone 120 with a spherical shape but other suitable shape may be utilized. For example, a multifocal diffractive zone 120 may be spherical shape or segment or variable radii. The enhancing DOF asphere can serve as base curve of the multifocal diffractive zone of on the other surface of the lens but with light passing though both enhancing DOF asphere multifocal diffractive zone to form multiple orders of diffraction, i.e. zero-order diffraction in both cases is of aspheric nature with intermediate and far foci and may be shaped to enhance DOF at distant vision.

FIG. 4 is a plan view of another preferred embodiment of an ophthalmic lens 150 made in accordance with the present invention which has multifocal diffractive zone 180 placed outside of the central refractive or diffractive zone 170. The enhancing DOF asphere can serve as base curve of the multifocal diffractive zone of on the other surface of the lens but with light passing though both enhancing DOF asphere multifocal diffractive zone to form multiple orders of diffraction, i.e. zero-order diffraction in both cases is of aspheric nature with intermediate and far foci and may be shaped to enhance DOF at distant vision.

The FIG. 4 demonstrates central zone 170 to be of a spherical shape but for generality it may be of any shape located centrally to the multifocal diffractive zone 180.

FIG. 5 demonstrates a Power graph of the lens described in the FIG. 3 where the power profile of the base curve includes far and intermediate foci. This power profile might be continuously varied as shown on the FIG. 5 or a combination of discrete intermediate and far powers. FIG. 5 shows the base curve power profile modulate between power in the intermediate and far power ranges. The combination of powers for intermediate and far powers could be of different forms but with the outcome to produce the enhanced depth of focus around far focus. The groove widths, heights and profiles are such that the corresponding wavefront shifts together with the contribution of base curve sags create contractive interference at the (−1)-order of diffraction corresponding to near focus with substantial diffraction efficiency to produce near vision in addition to far and intermediate vision produced by the aspheric base curve.

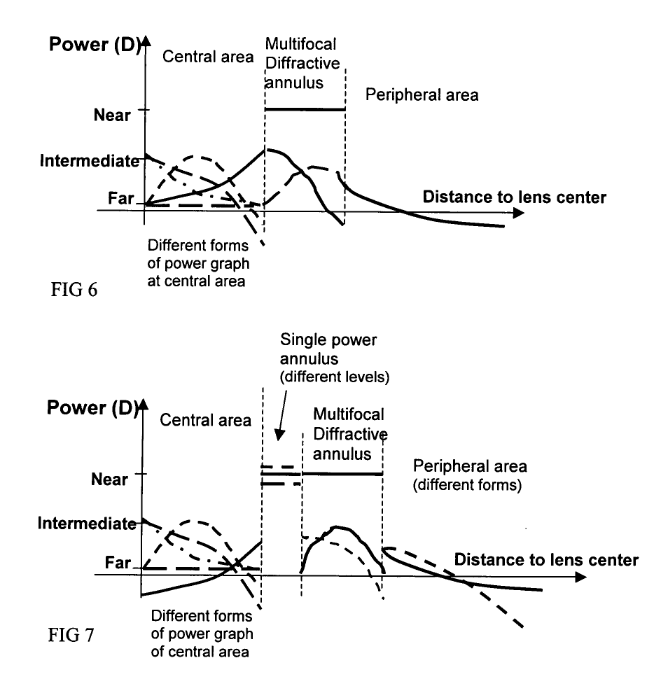

FIG. 6 is a Power graph of the lens described in the FIG. 4 where the power distribution along the central zone is represented of the variety of forms of single power or variable power profiles.

FIG. 7 is a Power graph of the lens described in the FIG. 4 where the power distribution along the central zone inside of the aspheric diffractive annulus is a combination of refractive zone of varying power profiles and single focus diffractive annulus (Kinoform) for near focus.

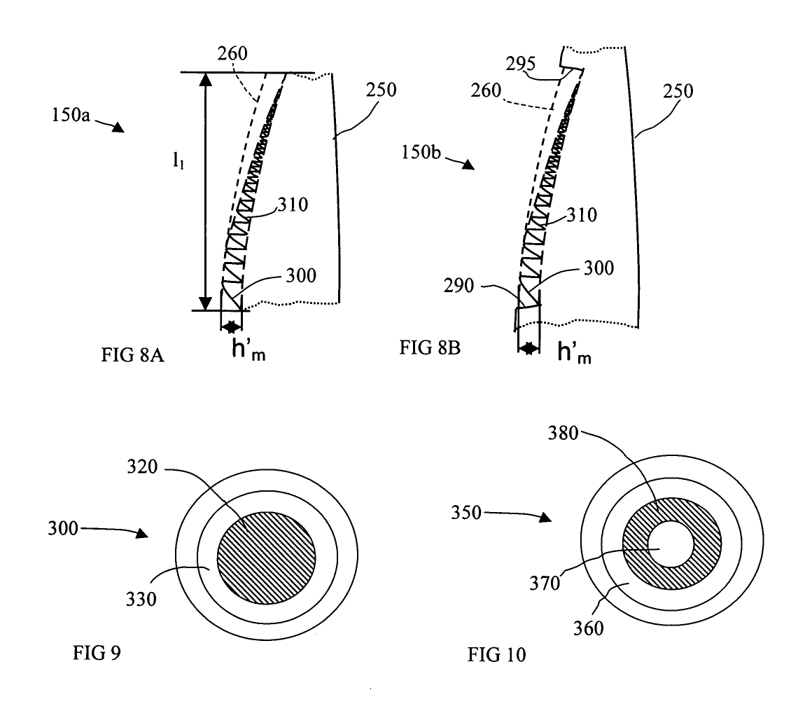

FIG. 8A is a profile view of the multifocal diffractive portion of lens 150a of width l₁ and posterior surface 250. The width l₁ is about from 0.4 mm to 2.5 mm. The figure demonstrates groove height h′ₘ that is continually reduced but in general they may be have the height reduction in steps. “Geometrical model” of the diffractive optic explains the reduction in grove height in order to direct the blaze ray in between the diffraction orders associated with far-intermediate zero-order and near foci non-zero order to split the light between aspheric multifocal 0-order and single focus (−1)-order though a rigorous diffraction theory is required to provide a fully quantitative solution for the groove widths, profile and heights meeting the specific transmittance requirements for far, intermediate and near foci.

FIG. 8B is a profile view of multifocal diffractive zone of lens 150b similar to those described by FIG. 8A with both zones being recessed by the depth 295, which is at least as deep as the groove height (h′ₘ). This construction is particularly useful when involve soft material when the diffractive surface can be pressed against an ocular tissue and deform its shape. For instance, for placement at the posterior surface of the intraocular lens or contact lens that may interface with the ocular tissue and deform the groove shapes.

FIG. 9 is a plan view of a preferred embodiment of the ophthalmic lens 300 made in accordance with the present invention which has multifocal diffractive central zone 320 FIG. 9 demonstrates the central zone 320 with a spherical shape but other suitable shape may be utilized. For example, a multifocal diffractive zone 320 may be spherical shape or segment or variable radii. The refractive aspheric zone 330 is placed outside of the multifocal diffractive zone either on the same or opposite lens surface.

FIG. 10 is a plan view of another preferred embodiment of an ophthalmic lens 350 made in accordance with the present invention which has multifocal diffractive zone 380 placed outside of the central refractive or diffractive zone 370 of a single power. A refractive aspheric zone 360 is placed outside of the multifocal diffractive zone either on the same or opposite lens surface. The refractive aspheric zone 360 is placed outside of the multifocal diffractive zone either on the same or opposite lens surface.

FIG. 11 is the example of an IOL Power Profile where the IOL is taken by itself. The Power Profile includes the near power distribution and Base (Far) power distribution. The Zero axis is taken at the power of best distant focus defined as the best image quality in terms of modulation transfer function. The vertical axis is scaled in IOL diopters or so called reduced diopters defined at the IOL plane.

The lens of the particular example was made of PMMA with spherical anterior surface of radius 12.3 mm, 0.8 mm thickness and aspheric multifocal posterior surface. Later consists of three aspheric zones: (1) refractive aspheric central zone of 1.5 mm diameter, (2) diffractive aspheric annular zone with 3.8 mm peripheral diameter and (3) refractive aspheric zone of 6 mm peripheral diameter.

Each zone is described by standard aspheric format:

$$z ( r ) = \frac{{cr}^{2}}{1 + \sqrt{( 1 - {c}^{2} {r}^{2} )}} + {A}_{4} {r}^{4} + {A}_{6} {r}^{6} + {A}_{8} {r}^{8} + {A}_{10} {r}^{10}$$

Where z(r)=surface sag; r=distance to the lens center; c=1/R=surface vertex curvature (R=surface vertex radius); Aᵢ=aspheric coefficients.

TABLE 1
Base Surface Zone parameters

| Para- | | | |
|---|---|---|---|
| meters | Zone 1 | Zone 2 | Zone 3 |
| R (mm) | −20.80 | −22.00 | −26.65 |
| Aᵢ | A₄ = 0.0066461 | A₄ = 0.0015878 | A₄ = 0.0001176 |
| | | −0.000160836 | A₆ = 0.00003538346 |
| | | | A₈ = −0.0000009912011 |

The diffractive structure is placed within the second zone to produce near power in addition to distant and intermediate powers of the base surface. The near power distribution is elevated over the base power by Add Power and spread out within 3.1 D and 3.7 D range. The groove width of the diffractive structure is about 0.17 mm at the internal zone diameter to about 0.08 mm at the periphery. The groove radii square do not follow the linear function of formula 1. The phase coefficients per the formula 3 of the diffractive structure measured in radians are:

α₁=0.191405; α₂=18.525067; α₄=1.783861 and α₆=−0.290676

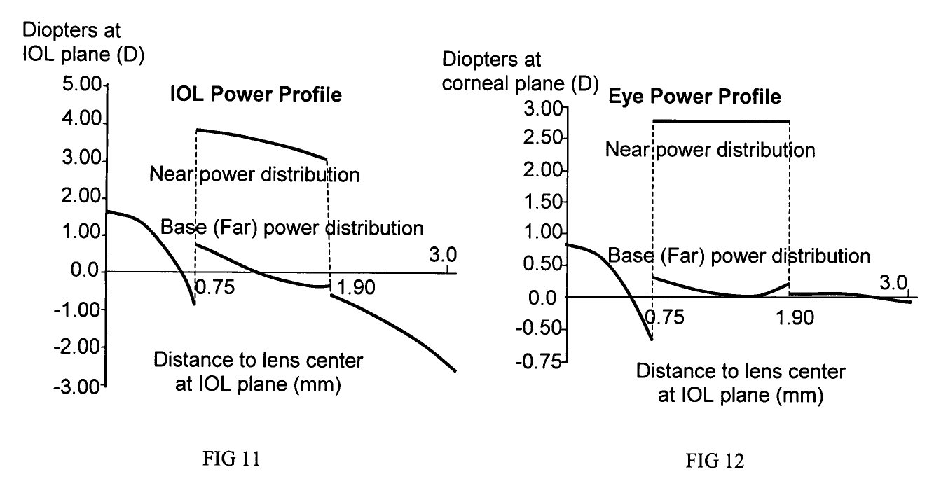

FIG. 12 is the example of an Eye Power Profile where the IOL is part of the Eye optical system. The IOL is the same as one described on the FIG. 11. The Zero axis is taken at the power of best distant focus defined as the best image quality in terms of modulation transfer function. The vertical axis is scaled in diopters at corneal plane. The reciprocal of the corresponding dioptric power defines a distance to the viewing object in meters. The eye system is taken with typical corneal surfaces: Anterior surface of 7.8 mm of vertex radius and conic constant of −0.21 and posterior surface of 6.5 mm radius and conic constant of −0.23.

The remarkable outcome of the Power Profile with the described above IOL was that the Near Power was presented by a single power of 2.78 D for near viewing, i.e. the near object at around 0.36 m˜14″ from the eye is in focus. A single level of near power profile points out that the diffractive structure creates a spherical wavefront to channel all designated by the structure light to Near Focus thus maximizing the near focus efficiency. The explanation is that the interaction of the diffractive structure with the wavefront of the total optical system is such that it creates a spherical wavefront for near focus. As far as distant focus is concern, the multifocal structure of the base surface results in intermediate focus and broad depth of focus at distant focus.

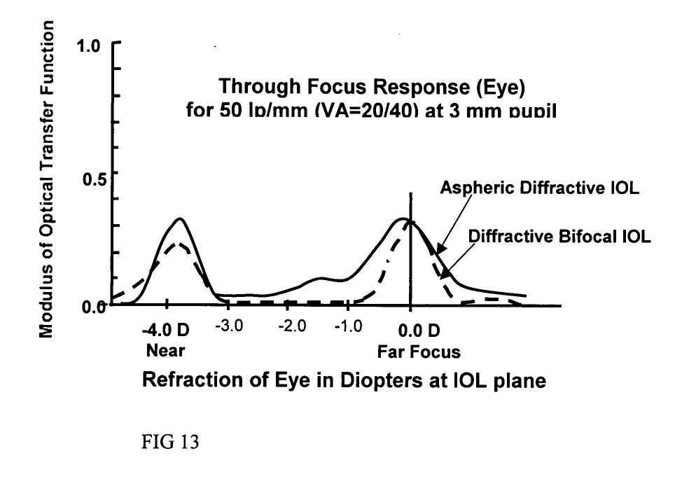

FIG. 13 demonstrates a Modulus of the Optical Transfer Function for different focus positions, so called Through Focus Response (TFR). The TFR graph represents image quality of the eye with preferred embodiment of the aspherical diffractive multifocal lens per FIG. 12 and transmittance function of its apodized diffractive bifocal zone per Table 2 below.

The diffractive structure of the annular zone of radii between 0.75 mm and 1.0 mm is for near vision as 100% of light is transmitted to near focus. The diffractive bifocal zone occupies the width between 1.0 and 1.9 mm radii. The design includes the groove apodization defined by the transmittance to Far and Near foci: T=T₀·(1−T₁·r−T₂·r²−T₃·r³−T₄·r⁴).

TABLE 2

| | Efficiency/Transmittance | | | | |
|---|---|---|---|---|---|
| | T₀ | T₁ | T₂ | T₃ | T₄ |
| Far focus | 2.508375 | 3.010962 | −2.98324 | 1.074313 | −0.13188 |
| Near focus | −16.4189 | 3.593128 | −4.31017 | 2.167969 | −0.3942 |

Thus, the apodization of the grooves within the diffractive bifocal zone is such that it starts with the height to direct all light along the diffraction order associated with near focus and then the heights are reduced to create the transmittance described by Table 2 until reaching close to zero to direct all light along the diffraction order associated with far focus.

The TFR of the preferred aspherical multifocal diffractive lens is compared with TFR of the multifocal diffractive lens where light is equally split between far and near foci (40.5% at each focus for the design wavelength with the rest of light is distributed between higher diffraction orders) for 3 mm lens aperture. The graphs demonstrate the remarkable advantage of the preferable aspherical multifocal diffractive lens over the multifocal diffractive lens by manifesting Intermediate vision capability in addition to the improved Near and Far vision capabilities as well as broad Depth of Focus to reduce sensitivity to a small refractive error.

What is claimed is:

1. A multifocal ophthalmic lens comprising:
a lens element having an anterior surface and a posterior surface;
a refractive zone, or base surface having aspherically produced multifocal powers disposed on one of the anterior and posterior surfaces; and
a near focus diffractive multifocal zone disposed on one of the anterior and posterior surfaces.

2. The lens according to claim 1 wherein the diffractive multifocal zone is an annulus.

3. The lens according to claim 1 wherein the diffractive multifocal zone is central zone.

4. The lens according to claim 1 wherein the refractive zone enhances depth of field around distant vision.

5. The lens according to claim 1 wherein the refractive zone comprises a distant and intermediate focus refractive multifocal zone.

6. The lens according to claim 1 wherein the diffractive multifocal zone enhances depth of focus around distant vision.

7. The lens according to claim 1 wherein said base surface of the diffractive multifocal zone comprises a distant and intermediate focus diffractive multifocal zone.

8. The lens according to claim 1 wherein the diffractive multifocal zone comprises a plurality of grooves, the grooves being apodized from a height directing light along a diffractive order associated with near focus to a height directing light along a diffractive order associated with distant focus.

9. The lens according to claim 1 wherein the diffractive multifocal zone is recessed into one of the anterior and posterior surfaces.

10. The lens according to claim 1 wherein said lens element is an intraocular lens.

11. The lens according to claim 1 wherein said lens element is a contact lens.

12. The lens according to claim 1 wherein said lens element is an artificial cornea.

13. The lens according to claim 1 wherein said lens element is a lamellar implant.

14. A method of designing an aspheric multifocal diffractive surface comprising
a) selecting a base surface with asphericity providing multifocal powers;
b) calculating diffractive structure phase coefficients that produce near focus for a selected add power to serve as non-zero order diffraction;
c) numerically calculating a 100% efficiency groove shape h(rᵢ) that produces the defined phase coefficients and groove width defining by the phase function modulo 2πp cycle where p=1,2, . . . ; and
d) modifying a groove shape h(rᵢ) of the diffractive zone to create a required balance of light between zero-order for distant vision and non-zero diffraction order for near vision for this groove location;

15. The method of calculating of light balance between distant and near foci of the diffractive groove defined by the formula:
$${h}^{′} ( {r}_{i} ) = \frac{S - [ {T}_{0} ( {r}_{i} ) - {T}_{- 1} ( {r}_{i} ) ]}{2 S} \cdot h ( {r}_{i} )$$
where T₀(rᵢ)=diffraction efficiency for distant focus, i.e. 0-order diffraction;
T₋₁(rᵢ)=diffraction efficiency for near focus, i.e. (−1)-order diffraction;
T₀(r)+T₋₁(r)=S, where S is within 0.81 to 1.0.
